(19) United States
(12) Patent Application Publication
(10) Pub. No.: US 2023/0044901 A1
(43) Pub. Date: Feb. 9, 2023

(54) SYSTEM AND METHOD FOR NON-FUNGIBLE TOKENIZATION OF INTELLECTUAL PROPERTY

(71) Applicant: Erich Lawson Spangenberg, Paris (FR)

(72) Inventor: Erich Lawson Spangenberg, Paris (FR)

(21) Appl. No.: 17/722,346

(22) Filed: Apr. 17, 2022

Related U.S. Application Data
(60) Provisional application No. 63/176,526, filed on Apr. 19, 2021.

(51) Int. Cl. G06Q 50/18; G06Q 40/06

(52) U.S. Cl. CPC G06Q 50/184; G06Q 40/06

(57) ABSTRACT

A system and method which assesses for stakeholders or ownership holders in intangible property (such as patent owners, licensees, lien holders, fractional-ownership holders, etc.) is disclosed, which utilize tokens such as NFTs (non-fungible tokens) to represent ownership of unique stakes in intellectual property. NFTs lend themselves to trading via any single or multiple blockchains and/or databases (for example, an Ethereum blockchain), whereby stakeholders are provided assurance that such intangibles have clear title and relative valuation, are not subject to potential adverse proceedings, and/or are valid and enforceable. The invention may use a blockchain for accessing data a way to insure marketable title with certain valuation as to the tokenized intellectual property right for trading, taking into account ownership and control variables, including fractional interests. potential joint inventorship and other encumbrances. The invention may be used to transparently facilitate pricing and trading of any stake associated with tokenized intellectual property internationally.

### PRIORITY CLAIMS

This application claims the benefit of U.S. Provisional Application Serial No. 63/176,526 filed on Apr. 19, 2021, the contents of which are incorporated herein.

### FIELD OF THE INVENTION

This invention is directed to a system and method for tokenizing intellectual property rights associated with patents, copyrights and other intangible property rights.

### BACKGROUND OF THE INVENTION

Traditionally, assessing and assuring the risks in the purchase of an asset often involves extensive and costly due diligence. Such due diligence may include manual and semi-automated searching of various and disparate records, databases and other sources. This problem is difficult enough to solve when the property is tangible, such as in the cases of real estate and personal property. However, the problem is further compounded when the asset is related to intangible property, such as patents, trademarks, and copyrights. This has been a long-term problem with few solutions, due to the governmental controls that often exist with respect to such assets, often on a country by country basis. Moreover, with patents, problems relating to joint ownership, joint inventorship, licenses, litigation and other invalidating proceedings (some not resolved), valuation of the intellectual property assets becomes very difficult without a real time online system, which would require that every registrar of every intellectual property right be encompassed within a single data hierarchy.

It is increasingly common that such intangible assets comprise the subject matter of, or are used as the collateral in, significant business transactions. Moreover, such intangibles often comprise a significant portion of the assets of a business and are subject to litigation involving the validity and/or infringement of the intangible.

Inasmuch as intangibles are gaining increasing importance in both domestic and international transactions, as well as in litigation, it is becoming increasingly important to provide parties to such transactions or who may be affected by litigation with more reliable, accurate, and cost-effective information through the due diligence process. Such information may include, for example, verification of the chain of title of the asset, identification of the encumbrances on the asset, the validity and enforceability of the asset, as well as past and pending litigation which involves or otherwise impacts the asset. Moreover, it becomes very desirable that valuation is ascertained across various decision-making boundaries, so that fair market value may be established, much the same way auctions are used for so many assets including works of art and automobiles. As the certainty among purchasers, investors, insurers and financers in the transferability and marketability of such assets increases, the market value of the asset should also increase, and should lead to more litigation being averted, transactions being completed, and investments being made. Eventually, such a platform would enable the trade of intellectual property rights (ownership, licensing rights, encumbrances, etc.), internationally, and in a transparent manner, akin to the manner in which securities are traded on stock exchanges across the world.

Thus, there exists a need for a system and method of assessing the valuation and risks associated with trading intellectual property rights on an international basis, including ownership, licensing rights, encumbrances, validity assurance and a uniform manner to assess such valuation. There also exists the need for a system and method which provides greater assurance among purchasers, investors, insurers and licensees of intangible property that such intangibles have clear title, are unencumbered, and/or are valid and enforceable. By assuring the valuation and marketable title as to all aspects of a stake or ownership (or management or control interest) in intellectual property, the rights or stakes may be freely and openly traded, on an international basis.

In addition, there exists a need for a system and method of improving the speed, accuracy and reliability of information delivered through the intellectual property assessment due diligence process so that decision makers can make better risk assessments, and more informed decisions, taking into account scope, validity, licensing rights, litigation, invalidity challenges and other potential adverse or beneficial proceedings, on an international and transparent basis. Traditional databases are often closed or proprietary, making them difficult for fulfilling this need. In this regard, there also exists the need for a system and method which delivers the results of such due diligence in real-time.

### SUMMARY OF THE INVENTION

The present invention relates to a system and method which facilitates the assessment of trading intellectual property rights or stakes in order to provide greater assurance among, purchasers, investors, licensees, insurers and financers of intangible property. Such intangible assets may include patents, trademarks, copyrights and other forms of intangible assets. The system and method of the present invention provides greater assurance that such intangibles have clear title, are otherwise unencumbered, are not the subject of litigation or other proceedings, and/or are valid and enforceable. While accomplishing this via traditional databases has been difficult for a myriad of reasons, use of NFTs (non-fungible tokens) is one optimal way to enable the preset invention. Indeed, NFTs are often transacted by way of at least one blockchain, including for example an Ethereum blockchain. More specifically, this invention is directed to at least one blockchain or multiple blockchains and/or databases (including as one example, an Ethereum blockchain) for trading tokenized intellectual property rights using NFTs, or non-fungible trading tokens. The invention is further directed to a system and method for enabling purchasers, licensees, investors, insurers and others with an interest in intellectual property to trade said interests via NFT trading, and to insure marketable title in said trade assets. In addition to trading, blockchain(s) can be used for IP tokenization, making IP (such as patents) easier to sell, license, commercialize, etc. (not limited to trading). Also, tokenization makes it easier to keep track of ownership, such as with fractional ownership. Tokenization can make it easier for crowdfunding/crowdsourcing of IP.

The use of an Ethereum blockchain or at least one other blockchain is one way to overcome prior art attempts to transact intellectual property trades, which must take into account security and international transparency in a real time or near real time environment. Intellectual property assets are relatively difficult to trade, given the complex nature of their valuation, including ownership (including joint ownership and/or joint inventorship), litigation, validity proceedings, licenses, encumbrances, and other local, state and national law concerns across all the countries of the world. Indeed, no single database has ever stretched to all the necessary constituents to accomplish the present invention, but through the use of NFTs across, for example, an Ethereum blockchain or at least one other blockchain, the present invention may be enabled and optimized.

The system and method of the present invention may comprise one or more of: (i) a blockchain and remote databases which comprise data and other information related to the valuation and risk assessment of the intangible property; (ii) a search engine which searches and retrieves from at least one blockchain or databases data and other information related to the valuation or risk assessment of the intangible property; (iii) a valuation ranking system or computational engine which utilizes objective assessment criteria to determine accuracies and inaccuracies in the information and data and generate a marketable title and valuation associated with the intangible property being assessed for risk; and (iv) an NFT based system which allows for the tokenization of all intellectual property rights of stakes under analysis by the present invention to enable the free trading of intellectual property tokens akin to the manner in stocks (equities) are routinely traded every day around the globe.

The system and method of the present invention may also comprise a system and method for developing valuations, monetization routes and collateralization opportunities pertaining to the intellectual property at interest.

In addition, the system and method of the present invention may further employ real-time or reactive computing systems and methodologies to enable due diligence to be conducted such that results generated by the system and method may be returned to the user during a single interactive computing session which accesses any number of networks or blockchains. While an Ethereum blockchain may be one optimal blockchain used to enable the present invention, any number of networks, a single blockchain or multiple blockchains may be used to transact the tokenized intellectual property rights or tokens, of NFTs.

NFTs are tokens that can be used to represent ownership of unique items such as intellectual property rights or stakes according to the present invention. NFTs may have any number of official owners at a time or just one, and they’re secured by at least one blockchain, such as for example, an Ethereum blockchain, so that unauthorized users cannot modify the record of ownership or copy or paste a new NFT into existence. The word “fungible” in the definition of NFT is significant due to the fact that fungible items can be exchanged because their value defines them rather than their unique properties. For example, ETH or dollars are fungible because 1 ETH / $1 USD is exchangeable for another 1 ETH / $1 USD. By using an NFT, the ownership or ownership group of any set of intellectual property or any single piece of intellectual property may be baked into the content itself, so that the NFTs may be freely traded, and percentage ownership or fractional ownership of intellectual property or pools of intellectual property may be distributed across a multitude or owners or stakeholders across the world, dynamically in real time or near real time, so that ownership stakes (ownership, licensing rights, encumbrances, liens, etc.) may be freely traded and exchanges may be built to enable the NFT trading. According to the present invention, provisions may be made so that every time a trade is affected, a commission or royalty may be attributed to the ownership, management or control group of the underlying intellectual property and/or their associated NFTs.

The system and method of the present invention transforms corporate patents into NFTs, applying tokenization to intellectual property (IP). An ecosystem to tokenize patents will allow intellectual property to be treated as business assets, making IP like patents easier to license, sell and commercialize. The application of NFTs to IP can also change the entire structure of the patent system and concept of a Global Patent Registry (GPR). NFTs are applied to Smart Patent Pooling, whereby the owner creates an NFT for the relevant patents via a smart contract. Once the NFT is created and on the blockchain-based GPR, digital title records are also incorporated into the overall system.

The present invention is a system and method of NFTs for IP including patents and patent applications, including the incorporation of Master Title Tokens. The present invention can work with patent offices, however it can also exist independently of patent offices. NFT is the representation to the rights transferred to the NFT per the underlying contact between the patent owner and the NFT. The NFT can insure title at both the patent level the NFT level, as well as insuring owner engagement with the NFT. The NFT can be a subset of patents or all the patents owned by an entity. The present invention can record the NFT contract using smart contracts and make that data publicly available. NFTs can also have attribute tokens, whereby The attribute could be an exclusive or non-exclusive IP license, the encumbrance, or the right to a % of future earnings/revenue. The attribute token may be a separate token that ties back to the NFT Master Title Token (MTC). This is a separate token where something other than title is involved. This facilitates inventor engagement with IP and provides a possibility to participate in future earnings as an incentive. The present invention also facilitates the ability to have multiple owners of a patent, set up at the MTC level.

In the preferred embodiment, the patent or patent application can become an NFT or can also be referred to as a Master Token (MTC). The title of the patent or application is insured, and the MTC is recorded at patent offices. Ricardian equivalence (Ricardian), which is an economic theory whereby financing spending out of current funds or future funds (and current deficits) will have equivalent effects on the overall value, is used in combination with smart contracts between the patent owner and MTC. A Patent or patent application MTC also allows for the possibility multiple existing or new patent owners. Once the patent or patent application MTC has been established, then attribute tokens can be incorporated. These attribute tokens can be many tokens or just many contracts with a master token. These attribute tokens can take the form of classic licensing, open source smart licensing, and investing. Classic licensing involves use of the patent by paying a set amount per year. Open source smart licensing involves licensing the patent to develop new technology, whereby the inventor has the rights to use the newly developed technology. Investors may also invest in the patent and get a percentage of future revenue generated by the patent. Other attribute examples include application tokens, inventor tokens, and tech area tokens. An application token is providing funding to get the application issued as a patent for future percentage or set amount return on investment. An inventor token is when the inventor gets a percentage of future income from the patent. A tech area token is a group of many MTCs together into one technology area.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is a line diagram illustrating a decentralized network.

FIG. 4 is a line diagram illustrating a distributed network.

FIG. 5 is diagram of the current patent process in relation to the present invention.

FIG. 6 is a diagram of the present invention.

### DETAILED DESCRIPTION OF THE PREFERRED EMBODIMENT

The present invention is a system and method that transforms corporate patents into NFTs, applying tokenization to intellectual property (IP). An ecosystem to tokenize patents will allow intellectual property to be treated as business assets, making IP like patents easier to license, sell and commercialize. The application of NFTs to IP can also change the entire structure of the patent system and concept of a Global Patent Registry (GPR). NFTs are applied to Smart Patent Pooling, whereby the owner creates an NFT for the relevant patents via a smart contract. Once the NFT is created and on the blockchain-based GPR, digital title records are also incorporated into the overall system.

The present invention is a system and method of NFTs for IP including patents and patent applications, including the incorporation of Master Title Tokens. The present invention can work with patent offices, however it can also exist independently of patent offices. NFT is the representation to the rights transferred to the NFT per the underlying contact between the patent owner and the NFT. The NFT can insure title at both the patent level the NFT level, as well as insuring owner engagement with the NFT. The NFT can be a subset of patents or all the patents owned by an entity. The present invention can record the NFT contract using smart contracts and make that data publicly available. NFTs can also have attribute tokens, whereby The attribute could be an exclusive or non-exclusive IP license, the encumbrance, or the right to a % of future earnings/revenue. The attribute token may be a separate token that ties back to the NFT Master Title Token (MTC). This is a separate token where something other than title is involved. This facilitates inventor engagement with IP and provides a possibility to participate in future earnings as an incentive. The present invention also facilitates the ability to have multiple owners of a patent, set up at the MTC level.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

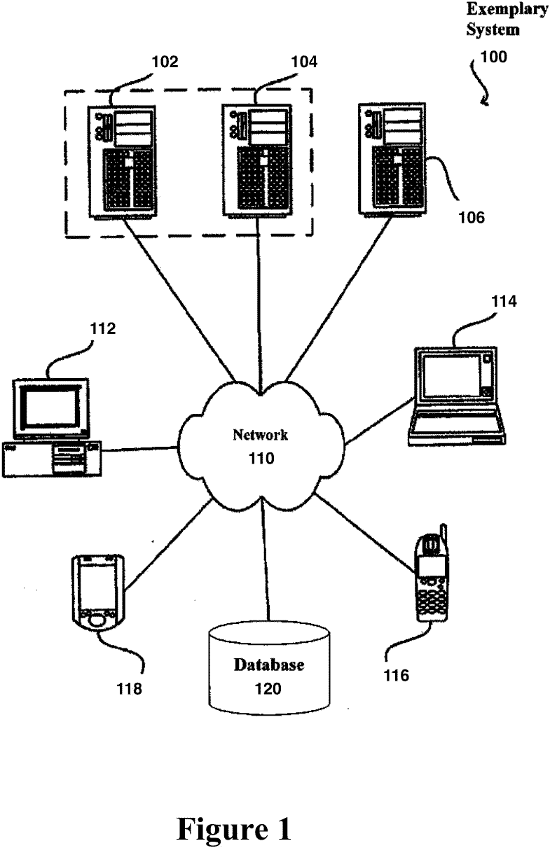

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet- enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java.RTM., C, C# or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

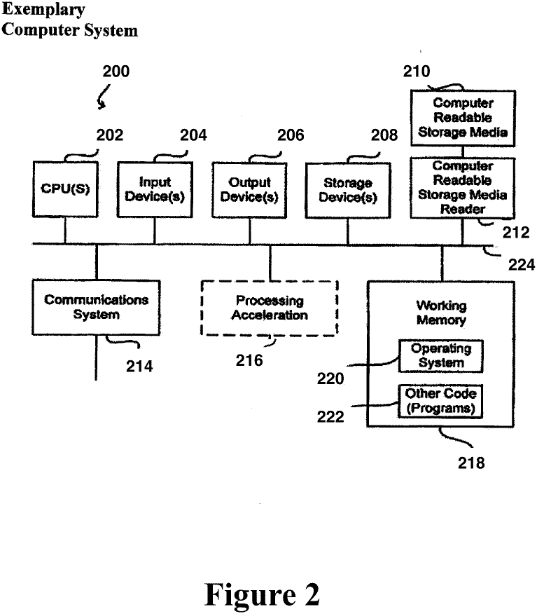

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid- state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on- demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user’s security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.RTM. processor or the like. Similarly, a computer system (and additional instances of an enterprise database, where more than one is present) and all of their components might be operator configurable using application(s) including computer code run using a central processing unit such as an Intel Pentium.RTM. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java.TM., JavaScript, ActiveX, any other scripting language such as VBScript, and many other programming languages as are well known. (Java.TM. is a trademark of Sun Microsystems, Inc.).

The present invention utilizes key aspects of blockchain technology. Blockchain technology uses digital fingerprints, version control and a distributed ledger to provide an immutable notary through a distributed asset ledger. Digital fingerprints incorporate time stamps on files to eliminate potential file tampering. Version control provides a means of connecting multiple iterations of files together using the same fingerprints. A distributed ledger provides a secure means of recording an immutable record to facilitate the transfer of funds between parties. Blockchain technology provides enterprise transaction support through smart contracts and a permission ledger. Smart contracts provide a means of attaching events and conditions to a transaction on the distributed ledger, and a permission ledger applies technology to global business transactions with privacy and better performance. Blockchain technology acts as a network of networks within a market, resulting in building trusted data and networks that operate at the level of the market.

By applying blockchain technology at the market level, the present invention transforms how IP assets are obtained, managed and transacted. Permissioned Blockchain allows multiple competing parties to operate from the same common database without revealing their data to the other party via the following means: trust, as the ledger keeps an immutable record of IP assets with rules governing who can update the records & how; control, as no central authority has access to all data on the network, the network is instead governed by rules; and privacy, through data and events that are made private and are both invisible and inaccessible to users who do not have authorization.

The present invention transforms how IP is obtained, managed and transacted by applying blockchain technology at the market level. Through blockchain technology, the present invention captures all IP asset events, whereby every party works from same record and titles are tracked. Each event for an IP asset is written to the blockchain, and rules dictate what data can be updated & how. All parties work from the same IP asset record and each change in ownership is a blockchain event. Parties have a secure environment where they can interact & transact on IP assets through: a private network channel for parties to interact; management of activity for both parties within the same location; data that can be shared safely over a private network; and paper contracts automated through smart contracts.

The permissioned blockchain network of the present invention fosters trust and globally improves cross border transactions. The blockchain network can be deployed globally, and only verified members are given access to the network. All parties can connect to a single platform and blockchain removes cross border cost & complexity. The present invention utilizes blockchain technology to capture the invention and introduce flexibility in how IP is stored & protected. Blockchain provides proof of inventorship and set up partnerships earlier once application is filed. Research is connected to the final patent and the present invention provides a secure platform for R&D and IP to work more closely.

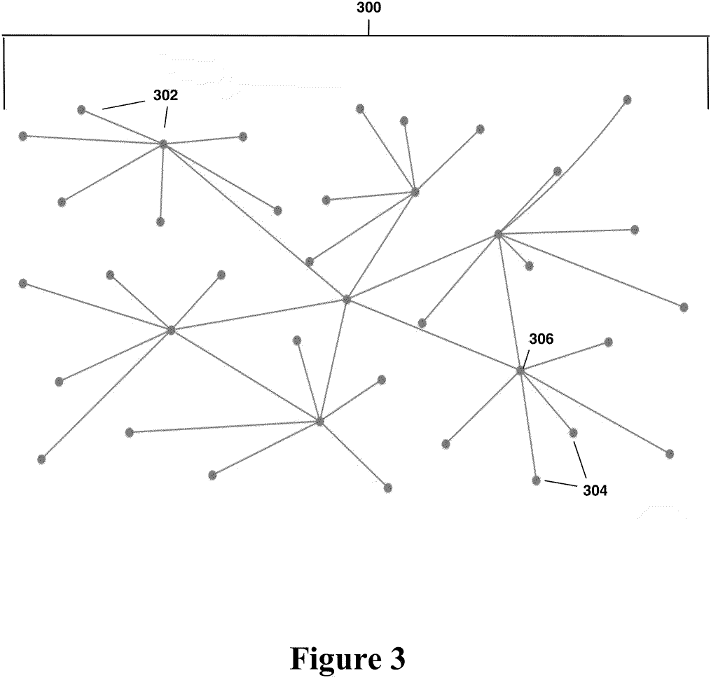

FIG. 3 is a line diagram illustrating a decentralized network. In accordance with the preferred embodiment of the present invention, the specific architecture of the network can be either decentralized or distributed. FIG. 3, generally represented by the numeral 300, provides an illustrative diagram of the decentralized network. FIG. 3 depicts each node with a dot 302 Under this system, each node is connected to at least one other node 304. Only some nodes are connected to more than one node 306.

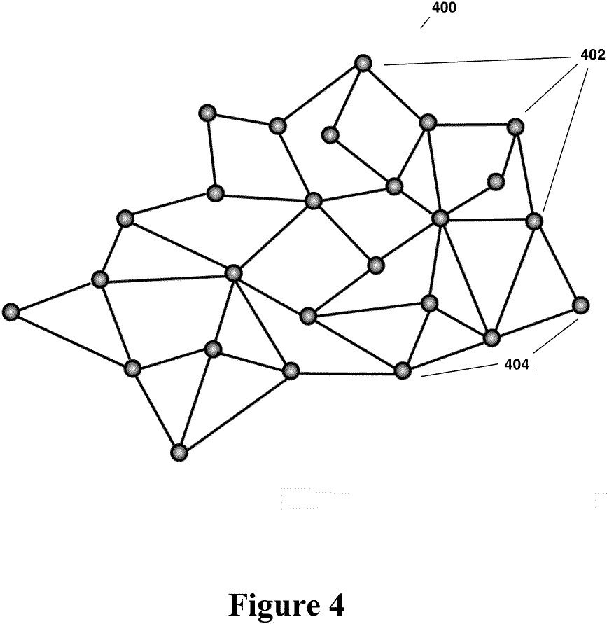

FIG. 4 is a line diagram illustrating a distributed network. For comparison purposes, FIG. 4, which is generally represented by the numeral 400, illustrates a distributed network. Specifically, the illustration shows the interconnection of each node 402 in a distributed decentralized network 400. In accordance with the preferred embodiment of the present invention, each node 402 in the distributed network 400 is directly connected to at least two other nodes 404. This allows each node 402 to transact with at least one other node 402 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

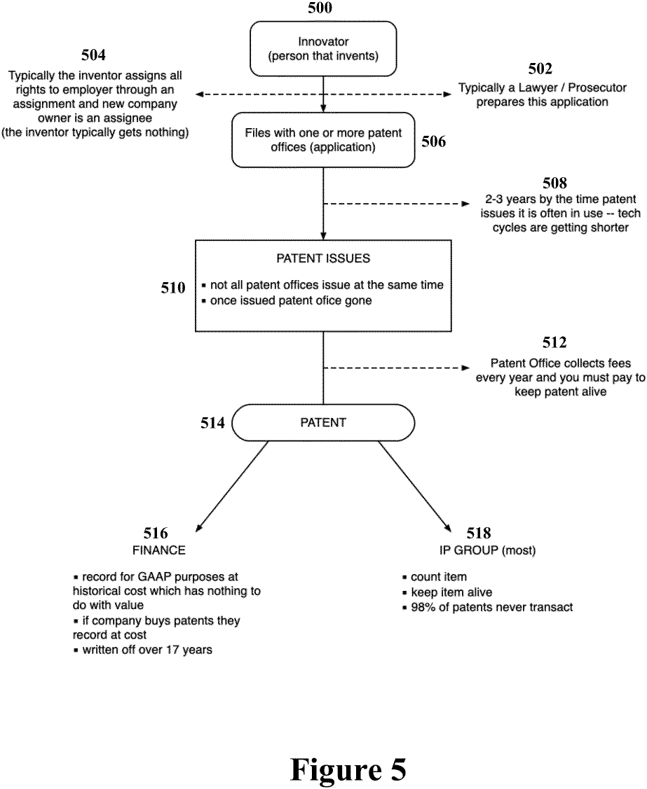

FIG. 5 is diagram of the current patent process. In today’s patent landscape, patents are issued on a per country basis, and there is no such thing as a global patent. This has created issues for patent discovery, patent transactions and uncertainty in terms of patent titles. As shown in FIG. 5, an innovator or inventor 500 with an idea for a new invention would typically work with a lawyer or patent prosecutor to prepare a patent application for the inventor’s idea 502. The inventor typically assigns their patent rights to their employer through an assignment 504, whereby the company is known as the assignee. In typical cases, the inventor gets nothing in terms of patent rights. Once a patent application is prepared, it is filed in one or more patent offices 506. It typically takes approximately 2-3 years for the patent to issue 508 and by then it is often in use. This is problematic as tech cycles are rapidly evolving and getting shorter. Once the patent issues 510, another problem is that not all patent offices issue the patent at the same time. The patent office collects fees every year in order to keep the patent alive 512. Once the patent 514 has issued, it can be financed 516 or typically acquired by an intellectual property (IP) group 518. If a patent is financed 516, it is recorded for Generally Accepted Accounting Principles (GAAP) purposes at the historical cost, which has nothing to do with the value of the patent. If a company buys the patent, it is recorded at cost, and written off after 17 years. If the patent is acquired by an IP group 518, it is counted as an item and kept alive, however the majority of patents never transact.

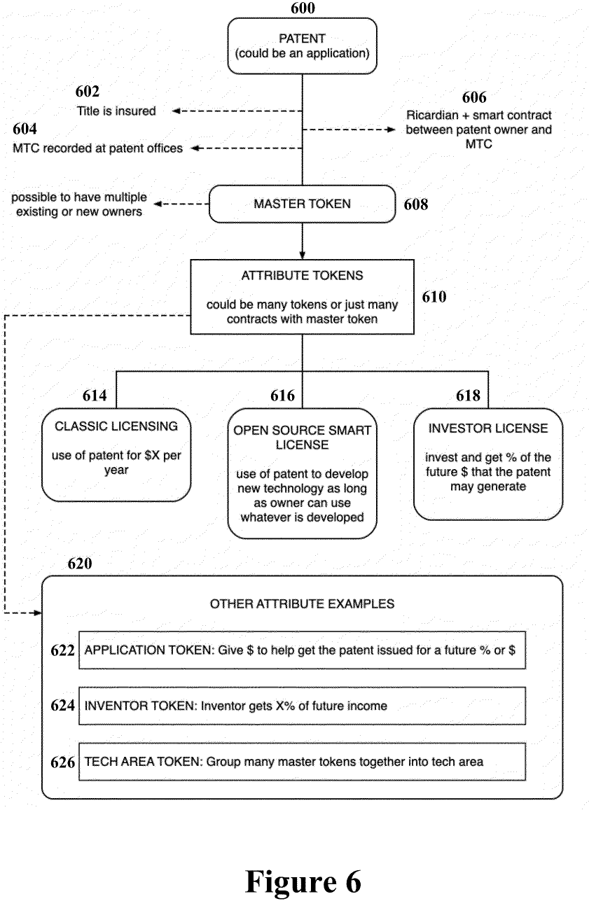

FIG. 6 is a diagram of the token plan of the present invention. In accordance with the preferred embodiment of the present invention, the patent or patent application 600 can become a Master Token (MTC) 608. The title of the patent or application is insured 602, and the MTC is recorded at patent offices 604. Ricardian equivalence (Ricardian) 606, which is an economic theory whereby financing spending out of current funds or future funds (and current deficits) will have equivalent effects on the overall value, is used in combination with smart contracts between the patent owner and MTC. A Patent or patent application MTC 608 also allows for the possibility multiple existing or new patent owners 610. Once the patent or patent application MTC has been established, then attribute tokens 612 can be incorporated. These attribute tokens can be many tokens or just many contracts with a master token. These attribute tokens can take the form of classic licensing 614, open source smart licensing 616, and investing 618. Classic licensing 614 involves use of the patent by paying a set amount per year. Open source smart licensing 616 involves licensing the patent to develop new technology, whereby the inventor has the rights to use the newly developed technology. Investors may also invest in the patent and get a percentage of future revenue generated by the patent 618. Other attribute examples 620 include application tokens 622, inventor tokens 624, and technology (tech) area tokens 626. An application token 622 is providing funding to get the application issued as a patent for future percentage or set amount return on investment. An inventor token 624 is when the inventor gets a percentage of future income from the patent. A tech area token 626 is a group of many MTCs together into one technology area.

The present invention represents patents as NFTs or digital assets. By translating patents into NFTs and storing the records on a blockchain network, these patents can be more easily sold, traded, commercialized or otherwise monetized, bringing new liquidity to this asset class for investors and innovators. The tokenization of intellectual property (IP) also provides greater transparency while making related transactions simpler and more cost efficient. By representing IP in this way, it can be more efficiently licensed, sold and commercialized. Organizations can also more easily view the IP as an asset on their balance sheet. While NFTs have become an increasingly popular way to represent digital art, sports memorabilia and even iconic Tweets, the early adoption of IP-based NFTs could usher in a transformation of how IP is treated by inventors and enterprises.

These NFTs will be stored and shared on the platform of the present invention, hosted on a cloud server such as IBM Cloud, and powered by blockchain technology such as IBM Blockchain. The present invention can use NFTs on a Global Patent Marketplace that already uses blockchain-based tools to make it easier to identify, research, evaluate and transact in patents digitally. The Global Patent Registry collects current, active and historical patent records in a single freely accessible registry. The present invention uses a patent marketplace on the blockchain, and the introduction of NFTs will only accelerate the opportunity for IP, which is notoriously difficult to manage, value and transact, to be treated as a liquid asset.

In addition to the enterprise, small and medium businesses, universities, law firms and other organizations already using the platform of the present invention, a broader ecosystem to support the use and exchange of tokenized patents will also be created including financial institutions, insurers, enterprises and other patent stakeholders.

The present invention is designed to transform the patent asset class by increasing transparency and promoting engagement, thereby encouraging innovation. The use of NFTs to represent patents will help create completely new ways to interact with IP. This is expected to benefit not only large enterprises that have significant intellectual property, but it will bring new opportunities to small and medium enterprises and even individual IP owners. We believe it will usher in new offerings by financial services firms and corporations to promote the evolution of a new patent asset class.

The present invention allows for the participation of many enterprises, governments, universities and small and medium enterprises (SMEs) around the world are already using the platform of the present invention, as well as Registry and Global Patent Marketplace of the present invention. For SMEs in particular, representing patents as digital assets is especially powerful because it allows IP to be treated as collateral or assurance of an organization’s value, also allowing it to be more easily leveraged when seeking funding. The present invention’s patent registry collects current, active and historical patent records in a single freely accessible registry with enhanced search enabled by AI. A broader ecosystem including financial institutions, insurers, enterprises and other patent stakeholders can also be encouraged to participate. The collaboration of the present invention’s platform and registry with blockchain and AI technology has the potential to transform entire industries. As businesses increasingly look to transform how they work with intelligent workflows, blockchain technology is a critical tool to increase transparency and reduce barriers.

The present invention can transform the patent asset class by increasing transparency and promoting engagement in order to encourage innovation. The use of NFTs to represent patents allows for new ways to interact with IP. The new opportunities will benefit not only large enterprises that have significant intellectual property, but it will bring new opportunities to small and medium enterprises and even individual IP owners. The present invention will usher in new offerings by financial services firms and corporations to promote the evolution of a new patent asset class.

The present invention incorporates blockchain and artificial intelligence to the platform of the present invention to help protect ownership information, generate patent and portfolio analytics and facilitate transactions, reporting and the next intelligent generation of patent pooling - an agreement among multiple patent holders to jointly license their IP. These tools are already available and in use today by enterprise, government, university and small and medium enterprises (SMEs) around the world. For SMEs, representing patents as digital assets is especially powerful because it allows IP to be treated as collateral or assurance of an organization’s value, also allowing it to be more easily leveraged when seeking funding. The present invention can incorporate additional AI and blockchain features to the platform, including enhanced reporting capabilities designed for business executives and IP professionals, like valuation, innovation, competitive analytics and FTO reports. This technology continues to be used in important areas to increase transparency and reduce barriers.

The present invention can also be used by banks, insurers, and capital markets. All of these parties lend, insure or invest money. In order to do any of those functions, they need collateral where things as simple as title and who owns the IP is clear, which is not simple to determine for IP today, to some indication as to its potential utility and value and what the IP covers. The present invention provides the answers to these and other critical questions and undisputed proof and indicative value of the collateral. This information is then captured in the NFT and is freely and publicly accessible.

The present invention allows for the development of an NFT IP trading market. Economists and history tell us that transparency, information, standardization and ease of interaction are critical to the formation of new asset classes and new markets. Capital tends to pursue opportunities that exhibit these attributes. NFTs technologically enables what was simply too complex or simply not possible before. IP trading is therefore more cost efficient because the cost of the trade can be significantly lower. Today it requires attorneys and contracts and paper-based processes. By using an NFT, the entire model is simplified. The smart contract is built into the token with standardized terms associated with every patent. The owner of the patent sets their contract terms, what is public and what is not. The capital and other transaction partners have the transparency, information standardization and ease of interaction they need.

The present invention works with the IP owner to evaluate and help set the initial indicative value—a reference range—of the token at the time of issuance. While it is anticipated that these indicative values will change over time, it is also anticipated that this range will over time demonstrates that this is a non-correlated asset class that itself makes IP more attractive to capital.

The present invention allows for all types of IP, including a copyright, trade secrets and patents, to be turned into an NFT. The present invention is first starting with patents and will expand into other IP as the platform advances to meet additional needs of the market participants. Licensing rights are a simple example that will benefit innovators, creators and capital.

The present invention allows for IP NFTs to be viewed as a balance sheet asset. Accounting for intangibles like IP has not kept up as intangibles become a more significant part of almost every balance sheet. With NFTs for IP a company, large and perhaps more importantly, small, can reveal to the market basic information about their IP profile that simply did not exist or was not easily accessible before. The “hidden value” they may not be getting credit for that leads to being undervalued can begin to be explained and understood. Since the IP in the form of an NFT has a value assigned to it, it can be referenced by investors, CFOs and capital. NTFs facilitate transparency, information and value flows that create new opportunities.

Title records for patents today are public and exist at over 150 patent offices around the world—there is no central depository of this information. The present invention works within the rules of that historic system. The difference is that with an NFT that title and other information will now be available to anyone in one place on the blockchain in one free, convenient step.

The present invention facilitates the possibility of fractional IP ownership. Fractional ownership of a patent today is difficult. Today, the USPTO requires a two -page fax to file a patent assignment. The present invention allows for fractional ownership at the NFT level, changing the behavior in how IP is owned, developed and commercialized. The NFTs are intended to be traded in public marketplaces besides the platform of the present invention. The present invention can utilize other public marketplaces to facilitate broader and more open trading.

The present invention uses patent NFTs as a solution to the title and contract standardization problem which is critical if IP is going to become an important credit eligible asset.

The present invention use of NFTs is important as a corporate use case for patents and critical for the platform of the present invention as the first significant corporate asset use case for NFTs. The NFTs will be insured as to title and validity by insurance companies that work with the present invention’s RM (Risk Management) platform. The present invention has written standardized contracts incorporating Ricardian economics and also provides an incentive for corporate use. The present invention uses Attribute Tokens then sit below the Master Token and embody licensing, commercialization, investment, mortgage rights, etc., which is not seen in the current IP structure.

In one embodiment, the present invention’s use of NFTs for patents incorporates the use of a master title token. Patent offices are not necessary to create this token, nor implement this token, nor use this token. However, patent offices can be included in this process. The NFT is the representation to the rights transferred to the NFT per the underlying contact between the patent owner and the NFT. As a result, the present invention can insure title at the patent level, insure title at the NFT level, and insure the person that engages with the NFT. The present invention can take a subset of patents or all the patents owned by an entity, as well as record that contract with the patent offices to put the world on notice.

In another embodiment, the present invention also uses attribute tokens, which can be in the form of: an exclusive or non-exclusive license; the encumbrance; and the right to a percentage of future earnings and revenue. Attribute tokens can be a separate token that ties back to the Master Title Token, which can be defined as sharding, the process of breaking up large segments of data into partitions that contain a subset of the overall data set. This process also creates a separate token where something other than title is involved. This can be beneficial in several different ways. In one example, inventors at big companies can get taken advantage of, and this process provides a solution for the inventors to participate in future earnings. In another example, it is currently next to impossible to have multiple owners of a patent, however the present invention allows for the ability to set up IP ownership as majority rule (or other structures) at the Master Token Level and not impact standing.

The present invention allows for multiple different ways to use NFTs in relation to IP, such as: each NFT can correspond to a different patent; an NFT can correspond to a fractional share of part of a patent(s); an NFT can correspond to part of a patent; an NFT can correspond to more than one patent; an NFT con correspond to a different patent application; an NFT con correspond to a different patent application or patent; and an NFT con correspond to a different pool of patents (such as grouping them by patent owner, technology area, or any other way of grouping them).

When the patent owner claims their NFT, the present invention presents the owner with the option of title insurance. Patent owners are encouraged to use title insurance in order to increase the probability of patent engagement, as not having title insurance can be seen as a problem with the IP, lowering the rating and valuation of the IP. Alternatively, several other potential options can be presented to patent owners. One option is that patent owners can be required to have at least some form of patent insurance (such as at least one of: title; validity; infringement; residual value; or any other types of insurance, etc.) before being able to transact patents on the platform of the present invention. Another option is that patent owners can be required to have patent insurance (such as at least one of: title; validity; infringement; residual value; or any other types of insurance, etc.) for NFTs. Another option is that patent owners can be required to have patent insurance (such as at least one of: title; validity; infringement; residual value; or any other types of insurance, etc.) before being able to transact NFTs, such as trading, selling, licensing, commercializing, etc. Another option is that patent owners can be required to have patent insurance (such as at least one of: title; validity; infringement; residual value; or any other types of insurance, etc.) before being allowed to have their patents added into patent pools. Another option is that patent owners can be required to have both patent title and patent validity insurance for NFTs. Another option is that patent owners can be required to have both patent title and patent validity insurance before being allowed to have their patents added into patent pools.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

What is claimed is:

1. A system for providing a tokenized intangible property monetization system comprising:
defining and assessing revenue potential of intangible property through the use of a tokenized version of said intangible property;
a blockchain and remote databases which comprise data and other information related to the valuation and risk assessment of the intangible property;
a search engine which searches and retrieves from at least one blockchain or databases data and other information related to the valuation or risk assessment of the intangible property;
a valuation ranking system or computational engine which utilizes objective assessment criteria to determine accuracies and inaccuracies in the information and data and generate a marketable title and valuation associated with the intangible property being assessed for risk; and
a non-fungible token based system which allows for the tokenization of all intellectual property rights of stakes under analysis by the present invention to enable the free trading of intellectual property tokens.
